(19) United States
(12) Patent Application Publication
(10) Pub. No.: US 2015/0244910 A1
(43) Pub. Date: Aug. 27, 2015

(54) EYEWEAR FOR ACQUIRING AN IMAGE

(71) Applicant: Nicholas Jamie MARSTON, Sheffield (GB)

(72) Inventors: Nicholas Jamie Marston, Sheffield (GB); Gordon Hutchesson, Sheffield (GB)

(21) Appl. No.: 14/431,017

(22) PCT Filed: Dec. 18, 2013
(86) PCT No.: PCT/GB2013/053350

§ 371 Date: Mar. 25, 2015

(30) Foreign Application Priority Data
Dec. 31, 2012 (GB) 1223510.7
Dec. 2, 2013 (GB) 1321268.3

(51) Int. Cl. H04N 5/225; H04N 5/77

(52) U.S. Cl. CPC H04N 5/2257; H04N 5/772

(57) ABSTRACT

The invention relates to eyewear 1 for acquiring an image comprising; a frame 2 arranged to be supported on a wearer's head to extend across the head in a position vertically adjacent at least one eye of a wearer; and at least one front facing camera 14 mounted to the frame 2 so as to be substantially vertically aligned with the at least one eye, the camera 14 having a camera axis for capturing the image; in which the position of the camera axis relative to the frame is offset or is adjustable about a first substantially upright axis, for aligning the camera axis with the line of sight of the wearer. The invention also relates to a kit of parts comprising eyewear 1; at least one pair of removable lenses 4 for attaching to the frame 2 of the eyewear 1; at least one camera unit 14 for attaching to the camera mount portion of the frame 2; at least one moulding 12 for covering the camera mount portion of the frame 2; and a tool 32 for adjusting the position of the camera unit 14.

### FIELD OF THE INVENTION

This invention relates to eyewear for acquiring an image, such as a pair of glasses for wear by a shooter of clay targets and/or game including a video camera.

### BACKGROUND OF THE INVENTION

Commercially available DVR glasses are available with a mini DVR camera lens placed immediately above the apex of the nose bridge in the centre of the glasses frame. Several problems were found with this type of unit. The first being that from the camera position, in relation to the right eye (of a right handed shooter) and the barrel, down which the right eye aligns to the target, the camera projects to the right of the gun. The resulting video does not film the gun barrel nor the target. The converse is true for a left hand shooter. To re-align the camera in its statutory position does not produce the desired result.

A basic object of the invention is the provision of improved eyewear for acquiring an image, such as shooting glasses.

### SUMMARY OF THE INVENTION

According to the present invention, there is provided eyewear for acquiring an image comprising; a frame arranged to be supported on a wearer's head to extend across the head in a position vertically adjacent at least one eye of a wearer; and a front facing camera mounted to the frame, the camera having a camera axis for capturing the image; in which the position of the camera axis relative to the frame is offset or is adjustable about a first substantially upright axis, for aligning the camera axis with the line of sight of the wearer.

Thus when worn during an activity which involves aiming at a target, such as shooting, the camera may be worn directly above or below the dominant eye (the eye which the wearer uses to align the gun sight with the target), and the camera axis may thus be positioned to align with the line of sight of the wearer's dominant eye, such that it points towards the target. In other words, the camera can mimic the expected angle of the eyeball in the eye socket. This can be done by adjusting the camera and using trial and error, or the angle of the camera axis can be set according to the expected angle of gaze relative to the head for a particular activity.

For example in the case of shooting a gun, it has been found that the camera axis may suitably be offset to face outwardly at an angle of approximately 30 degrees. In the case of an adjustable camera, a range of adjustment of about 40 degrees has been found to be suitable for a range of activities (eg from about 10 degrees inwardly to about 30 degrees outwardly).

The eyewear may be in the form of spectacles or glasses, and a microphone for acquiring audio input associated with a picture and/or video acquired by the camera may also be provided. The eyewear may also comprise apparatus for recording the acquired image, being at least one picture or video, and/or a data storage device for storing the image(s) or video or audio input, and/or means for transmitting the acquired image to another device, such as a transmitter. There may be a device such as a button or switch for receiving a user input, the device being arranged to initiate image acquisition by the camera.

Preferably, in order to provide further accuracy in aligning the camera axis with the line of sight, the position of the camera axis is also offset or adjustable about a second substantially lateral axis, the second axes being perpendicular to the first axis. Thus the camera may face upwardly or downwardly, to mimic the position of the eyeball. Again in the case of shooting, the line of sight may be angled upwardly, and it has been found that a suitable offset for the camera axis is to face upwardly at an angle of approximately 5 degrees. A suitable range of angular adjustment about the second axis may be about 40 degrees (eg from about 10 degrees downwardly to about 30 degrees upwardly).

Thus the camera may comprise a camera body and a camera housing secured to the frame, and the camera axis may be adjustable by relative movement between the camera body and the camera housing. A locking member may be provided which is actuable selectively to permit relative movement between the camera body and the housing, or to secure the camera body in position in the housing.

Furthermore, the camera position may be offset from an upright position relative to the frame about the camera axis, or is adjustable about the camera axis relative to the frame, for aligning the acquired image with a tilt angle of the wearer's head. Such an angle of tilt may for example be about 5 degrees, with a suitable range of adjustment being about 40 degrees (20 degrees in either direction). Conveniently the camera body is substantially part spherical, and the housing is correspondingly shaped, to allow such movement around three axes. Thus the camera may also mimic a tilt angle of the wearer's head.

In order to take account of the different spacing of the eyes of different wearers, the camera position relative to the frame is preferably adjustable in translation along the frame, to allow vertical alignment of the camera axis with the centre of the eye of the wearer.

For example, the frame may comprise a camera mount portion for example in the form of a rail, and the camera may arranged to be slidably engaged with the camera mount for translational movement thereon, and is arranged to be selectively secured in position on the mount. Preferably, the frame is arranged to extend adjacent both eyes of the wearer. Two camera mount portions may be provided, one aligned with each eye, so that the camera may be mounted to either portion dependent upon the wearer's dominant eye, or a camera may be mounted to each portion to give a 3D view.

The height of the camera relative to the wearer's eye may also be adjustable, for example by adjusting the position of the frame on the wearer's head using a bridge piece which may be attached in a number of different vertical positions.

According to a further aspect of the present invention there is provided a pair of glasses for a user, comprising: an eyeglass frame having a digital camera at least partially embedded above left or right dominant eye, the digital camera being configured to acquire an individuals line of sight, such that the camera does not face directly forward but faces outward at an angle of approximately 30 degrees and records at least one picture or short video, a user activated device configured to receive a user input to activate acquisition of the individual picture by said camera; a data storage device configured to store one or more individual pictures or short videos acquired by said camera; and a microphone configured to acquire audio input to be recorded to said data storage device, wherein the acquired audio input stored in said data storage device is associated with the individual picture/video acquired by said camera and stored in said data storage device.

Preferred or optional features of this aspect are as follows. The eyeglass frame further includes a universal tensioned three axis adjustable joint and wherein said camera is mounted such that the camera does not face forward, but faces at an angle from the perpendicular direction of the plane formed by the lens holder adjacent to the nose bridge.

The camera is mounted on an angled surface at a forward portion of the eyeglass frame above the left or right eye.

The camera angle is set at approximately 30 degrees to the left above the right eye and 30 degrees to the right when positioned above the left eye.

The data storage device is removably coupled to the glasses on the first or second temple.

A removable memory card slot is provided at a lower portion of the one of the first or second temples.

The camera is operable to automatically take at least one picture/video without any required user interaction after a previous picture/video is taken.

As stored in said data storage device, the acquired audio input is linked to at least the individual picture/video acquired by said camera.

The camera or said user input device is configured to initiate storage of the acquired picture/video and audio input to said data storage device.

The acquired audio input is acquired during a predetermined period of time proximate to when the individual picture is acquired by said camera.

The acquired audio input comprises an audio recording of audio sounds at the location where the picture/video was taken.

A pair of glasses further comprises: at least one electronic component for wireless connection, wherein the picture/video taken by said camera can be wirelessly transmitted to another device.

A data storage device is a removable media card.

A data storage device is a removable memory card, and wherein said pair of glasses further includes a connector adhered by or to one of the first and second temples, said connector being operatively connected to said camera, and wherein said removable memory card is configured to operatively connect with said connector to permit storage in said removable memory card of the one or more individual pictures/videos acquired by said camera.

A connector is a USB or Mini jack plug connector.

According to yet another aspect of the invention, of independent significance, there is provided a pair of glasses for a user, comprising: an eyeglass frame having at least first and second temples; a digital camera at least partially embedded in said eyeglass frame directly above the left or right eye, said camera being configured to acquire one or more images; a user input device configured to receive a user input to activate acquisition of the one or more images by said camera; and a removable memory card connector provided at one of the first and second temples, said removable memory card connector being electrically connected to said camera.

Preferred or Optional Features of this aspect are as follows.

The removable memory card connector is adhered to or at least partially embedded within the one of the first and second temples.

The one or more images acquired by said camera are able to be stored to a removable memory card that is connected with said removable memory card connector.

According to still a further aspect of the invention, of independent significance, there is provided a pair of glasses for a user, comprising: an eyeglass frame having at least first and second temples; a rechargeable battery power source at least partially embedded in said first or second temple frames.

The invention thus provides action video camera glasses for including, but not limited to the shooting of clay targets, game, pest and vermin, to reveal the relationship between the muzzle of the gun (as seen by the shooter) and the target.

Development has been concentrated on securing unique optimum dimensions and camera angles, to suit a wide range of the population in terms of each individual's facial architecture. Research revealed that a minute incremental adjustment is required to achieve this.

One embodiment pertains to a pair of glasses with a camera fixed to the eyeglass frame above the left or right eyepiece.

The camera is partially or fully embedded in the glasses. The camera is adjustable by +or −10 degrees in all directions from the designated optimum position the camera being fixed to the eyeglass frame by a universal tensioned three axis adjustable joint. In another embodiment, the camera is attached to the eyeglass frame and set at the designated optimum position. The glasses can also include one or more various other electrical components. These other electrical components can work separately or in conjunction with the camera.

According to another aspect of the invention, there is provided a kit of parts, comprising; eyewear (optionally as described above); at least one pair of removable lenses for attaching to the frame of the eyewear; at least one camera unit for attaching to the camera mount portion of the frame; at least one moulding for covering the camera mount portion of the frame; and a tool for adjusting the position of the camera unit.

The invention extends to any novel aspects or features described and/or illustrated herein.

Further features of the invention are characterised by the other independent and dependent claims

Any feature in one aspect of the invention may be applied to other aspects of the invention, in any appropriate combination. In particular, method aspects may be applied to apparatus aspects, and vice versa.

Any apparatus feature as described herein may also be provided as a method feature, and vice versa. As used herein, means plus function features may be expressed alternatively in terms of their corresponding structure.

It should also be appreciated that particular combinations of the various features described and defined in any aspects of the invention can be implemented and/or supplied and/or used independently.

In this specification the word or can be interpreted in the exclusive or inclusive sense unless stated otherwise.

The invention extends to methods, apparatus, eyewear and/or kit of parts substantially as described herein and/or substantially as illustrated with reference to the accompanying drawings.

### BRIEF DESCRIPTION OF THE DRAWINGS

In order that the invention may be more readily understood, reference will now be made, by way of example, to the accompanying drawings, in which:

FIG. 1 is a perspective view of an article of eyewear according to one embodiment of the invention;

FIG. 2 is a rear view of the eyewear of FIG. 1;

FIG. 3 is a partial front view of the eyewear of FIG. 1;

FIG. 4 is an alternative front view of the eyewear of FIG. 1 with a further camera attached;

FIG. 5 is a perspective view from behind of the camera and camera mount of the eyewear;

FIG. 6 is an enlarged partial perspective view of the camera and mount of FIG. 5;

FIG. 7 is a perspective view of the camera unit of the eyewear of FIG. 1;

FIG. 8 is a top view of the camera unit of FIG. 7;

FIG. 9 is a cross-sectional view along the lines IX-IX of FIG. 8;

FIG. 10 is a cross-sectional view along the line X-X of the camera unit of FIG. 8;

FIG. 11 shows the range of angular adjustment of the camera body of FIG. 7;

FIG. 12 shows an adjustment tool for adjusting the position of the camera body;

FIG. 13 is a schematic top view of a wearer's head with the eyewear of FIG. 1;

FIG. 14 is a side view of FIG. 13;

FIGS. 15a to 15c are schematic views of a wearer aiming at a target;

FIG. 16 is a diagram of the various components of the eyewear;

FIGS. 17 and 18a to 18c show prototype glasses according to another embodiment of the invention set up for a predominantly right handed shooter;

FIG. 19 is a diagrammatic drawing showing the designated optimum position of said camera of FIGS. 17 and 18 for a predominantly right handed shooter. This designated optimum position is reversed for a predominantly left handed shooter; and

FIGS. 20a to 20c show the glasses of FIGS. 17 and 18 set up for a predominantly right handed shooter.

### DETAILED DESCRIPTION OF THE DRAWINGS

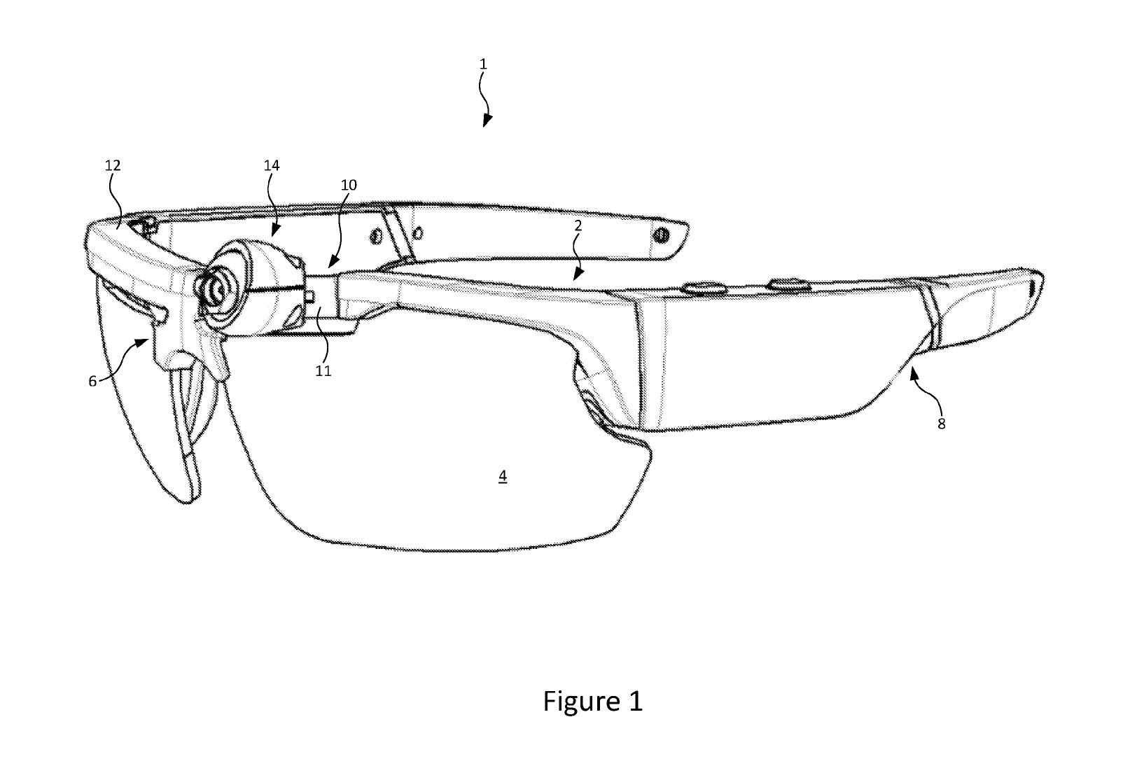

Referring to FIGS. 1 to 3, an article of eyewear 1 comprises an upper frame component 2 similar to a spectacle frame, having a bridge region 6 for placing over the nose of the wearer, and a pair or arms 8 for placing over the ears, to support the frame 2 extending across the face adjacent the head just above the wearer's eyes. The frame 2 includes a camera mount in the form of a cavity 10 positioned above the expected position of the centre of the wearer's eye. The cavity comprises a rail 11 for attaching a camera unit 14.

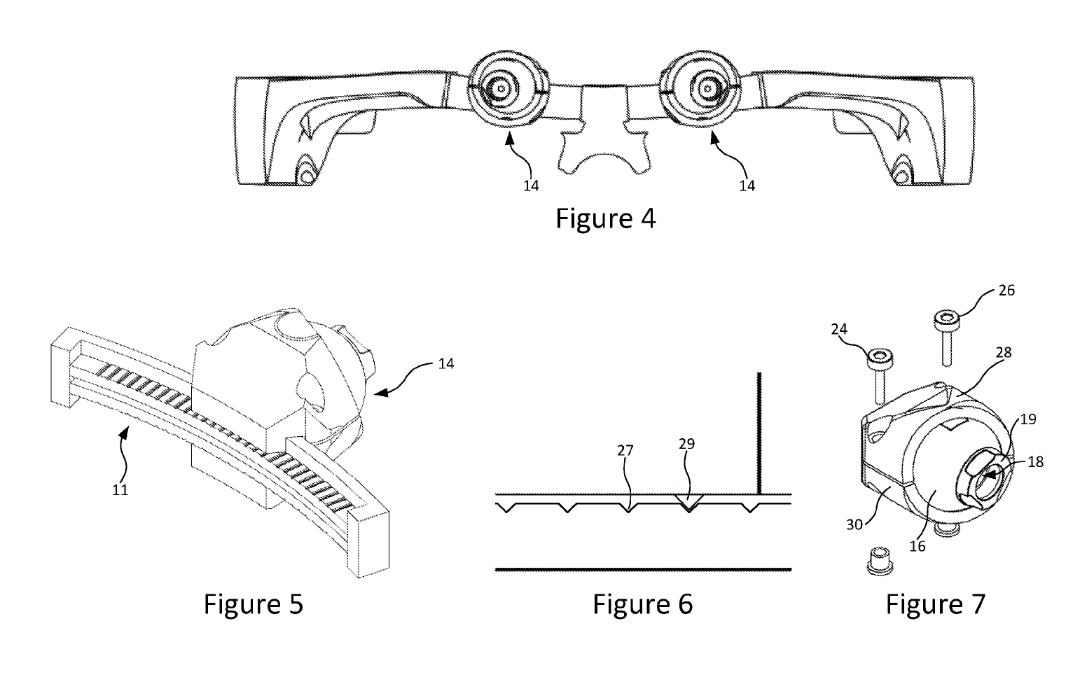

In this example the cavity 10 is above the left eye, for a left eyed wearer. Alternatively the cavity may be provided over the right eye for a right eyed wearer, or there may be a pair of cavities, one over each eye. In this case, one of the cavities may be covered with a moulding 12 to match the contour of the frame 2. Alternatively, a camera unit 14 may be provided in both cavities for providing a 3D view, as shown in FIG. 4.

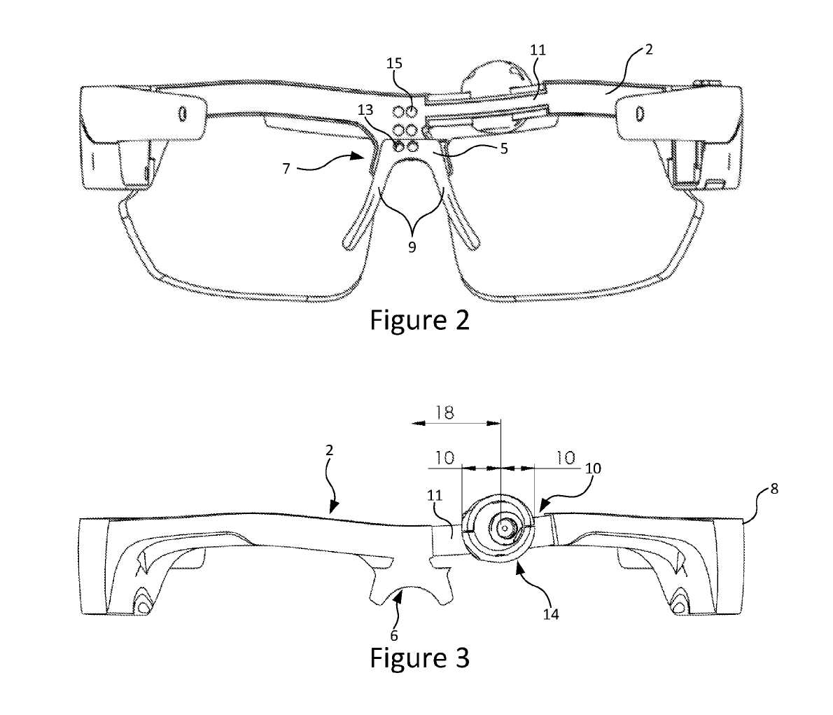

The eyewear 1 may include a nose bridge piece 7 (see FIG. 2) having an upper portion 5 and two downwardly extending arms 9. The upper portion 5 is provided with a pair of apertures 13 for securing the bridge piece 7 to the bridge region 6 of the frame. The bridge region 6 is provided with a series of corresponding apertures 15 such that the bridge piece may be secured to the frame in a selected vertical position, for example using a pair of small screws (not shown) so as to adjust the height of the camera. The arms 9 may be flexible such that the bridge piece 7 may twist to locate the frame in a level position in relation to the wearer's eyes.

The eyewear may also include lenses 4 extending in front of the wearer's eyes, which may be removable and interchangeable so that the wearer may select lenses with a required property, such as impact resistance or an optical property such as a level of shading, and may optionally be arranged to carry a lens for correcting a visual defect such as short sight.

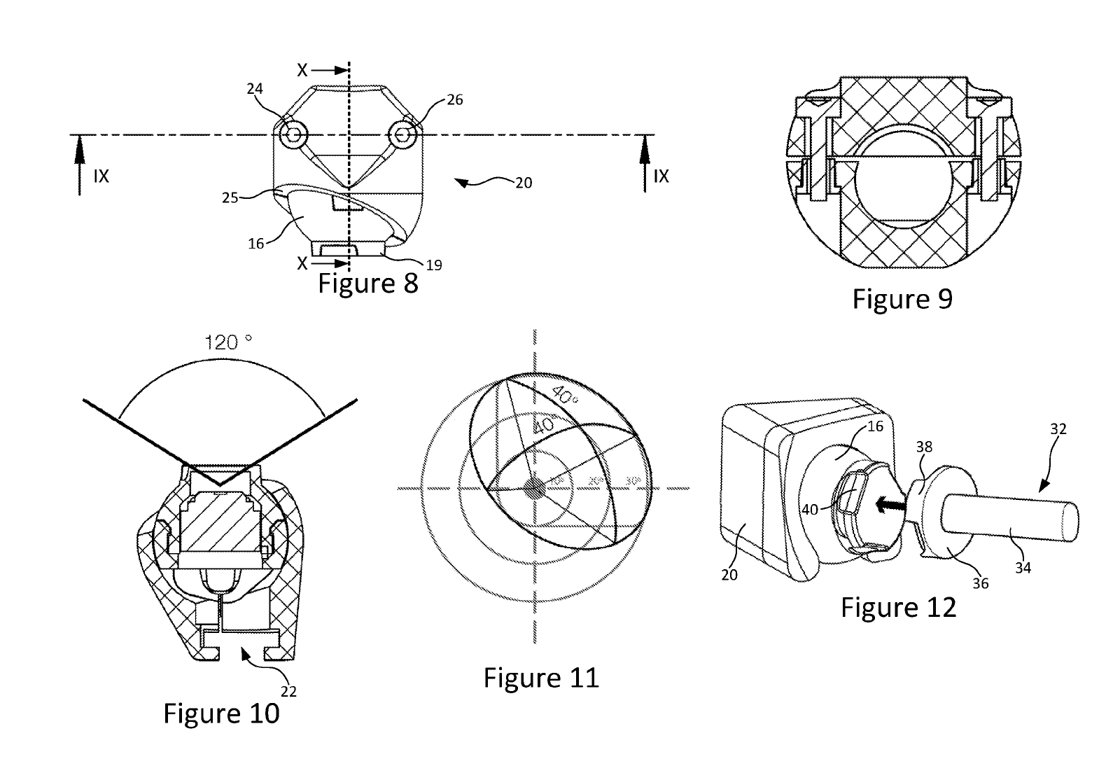

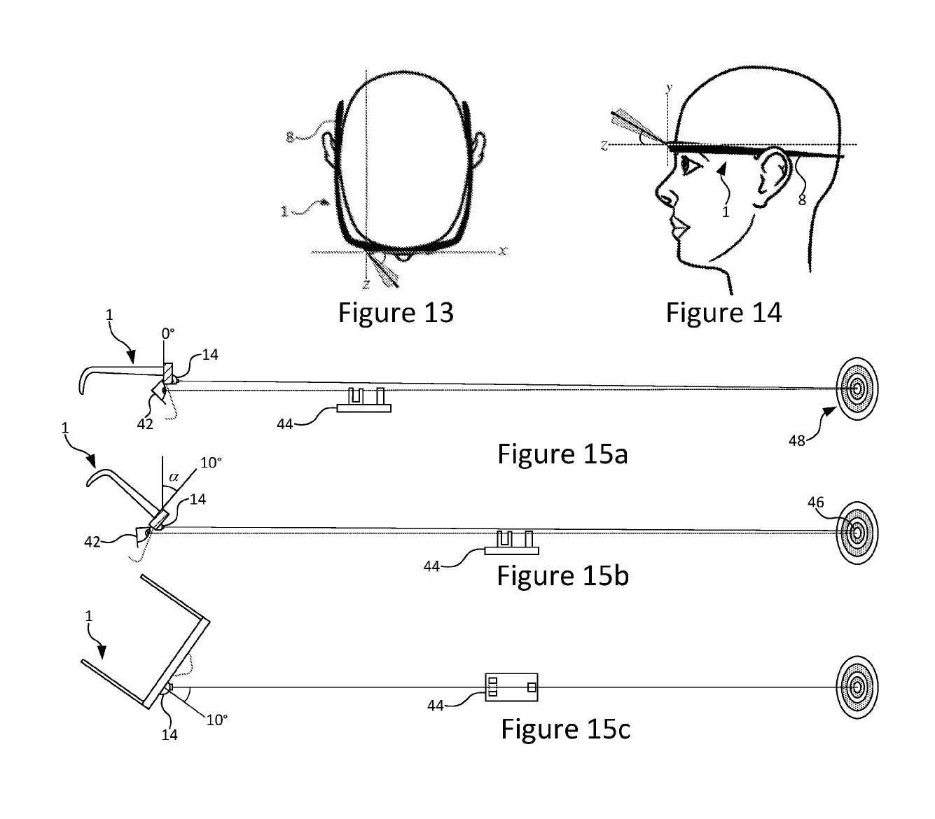

The camera unit 14 is mounted to the rail 11 so as to be positioned above the dominant eye of the wearer. Referring also to FIGS. 5 to 12, the camera unit 14 comprises a camera body 16 carrying the camera with a camera lens 18 having a projecting lens rim 19. The arrangement is such that the camera may have a field of view of about 120 degrees (see FIG. 10).

The camera body 16 is housed in a shroud 20. The shroud 20 includes a mounting portion comprising a groove 22 shaped to receive the rail 11 for sliding movement along the rail (see FIG. 5). The sliding or translational movement of the camera unit allows adjustment of the lateral position of the camera so that the camera axis can be aligned directly above the centre of the wearer's eye. Data from populations in various countries suggests that centre of the cavity 10 should be positioned laterally about 18 mm from the centre of the bridge region 6, and that the cavity 10 should allow translational movement of the camera of about 6.5 mm either side of this point in order to be able to align the camera with the eyes of most users.

The camera body 16 can be substantially spherical in shape so that the camera may be adjusted about both X and Y axes, being the lateral or substantially horizontal axis and the upright or substantially vertical axis respectively, which are perpendicular to the camera axis 24 passing through the optical centre of the lens when the camera is facing forwardly (the Z axis), as shown in FIGS. 13 and 14. In this way the direction of the camera axis may be moved both up and down and side to side to point the camera in the required direction to align with the wearer's line of sight when performing a particular activity, such as aiming a gun at a target. In addition the camera may optionally be rotatable about the camera axis, to align the acquired picture with the tilt of the wearer's head.

The shroud 20 is shaped so as to allow a required range of movement of the projecting lens rim 19. In this example, in order to allow the camera to face the wearer's line of sight, or alternatively to face directly forward where this is required, the required range of movement of the camera is from about +30 to −10 degrees around the X axis, and between +10 and −30 degrees around the Y axis, giving a sweep area of 40 degrees about each axis as shown in FIG. 11. Thus the shroud has a front face 25 which, in the case of a left mounted camera as shown in the figures, is inclined inwardly and upwardly. The range of movement for rotation about the camera axis may be about ±20 degrees.

A typical camera position to align with a wearer's line of sight when aiming at a target would be about 30 around the Y axis, about 5 degrees about the X axis, and about 5 degrees about the Z axis. In other words, the wearer tends to position the head when looking down a gun sight such that the dominant eye is pointing about 30 degrees towards the centre of the face, and about 5 degrees upwardly, with the head tilted towards dominant side by about 5 degrees. This is illustrated in FIGS. 15a to 15c, showing how the camera can effectively replicate the angle of the wearer's eye 42 aiming a gun sight 44 at the centre 46 of a target 48. In the case of other sports or activities such as archery or pool, these angles may of course vary. In addition, the shroud may be differently shaped to allow a different range of camera adjustment.

The shroud 20 is provided in upper and lower parts 28, 30 which seat together around the camera body and are secured using a pair of adjustment screws 24, 26. The screws 24, 26 may be loosened to allow the position of the camera to be adjusted, and tightened to secure it in place. Unscrewing the inner screw 24 allows the two parts 28, 30 to move apart, widening the groove 22 so as to loosen the groove 22 from the rail 11, such that the camera unit 14 may translate along the frame 2 by sliding on the rail. The rail 11 may be provided with a series of spaced notches 27 on one or both sides thereof, and one or both of the parts 28, 30 of the camera body may be provided with a tooth 29 which may locate in one of the notches to secure the unit 14 in the required lateral position. The inner screw 24 may then be tightened such that the two parts 28, 30 move together and the groove 22 grips the rail 11 with the teeth 29 locking into the respective grooves 27.

Similarly, slackening the outer screw 26 releases the camera housing 16 for movement within the shroud 20. The outer screw 26 can be partially tightened when the camera is roughly in position. Referring to FIG. 12, an adjustment tool 32 may be provided for fine tuning the position of the camera body 16 before further tightening of the screw 26 to secure it tightly in position between the two shroud parts. The tool 32 may comprise a handle 34 and a shaped grip 36 for cooperating with the correspondingly shaped lens rim 19. For example the grip 36 may have three prongs 38 for cooperating with three corresponding flattened areas 40 on the outer face of the lens housing 19, such that the body 16 will turn with the tool when the prongs are pushed over the lens housing 19 and the tool is manipulated.

Conveniently, the grip 36 may terminate at the other end with a screw driver element (not shown) such that the tool may also be used for manipulating the adjustment screws 24, 26.

It will be understood that, where the eyewear is designed for use in a particular activity, the camera position may be provided fixed in the required offset position, rather than being adjustable.

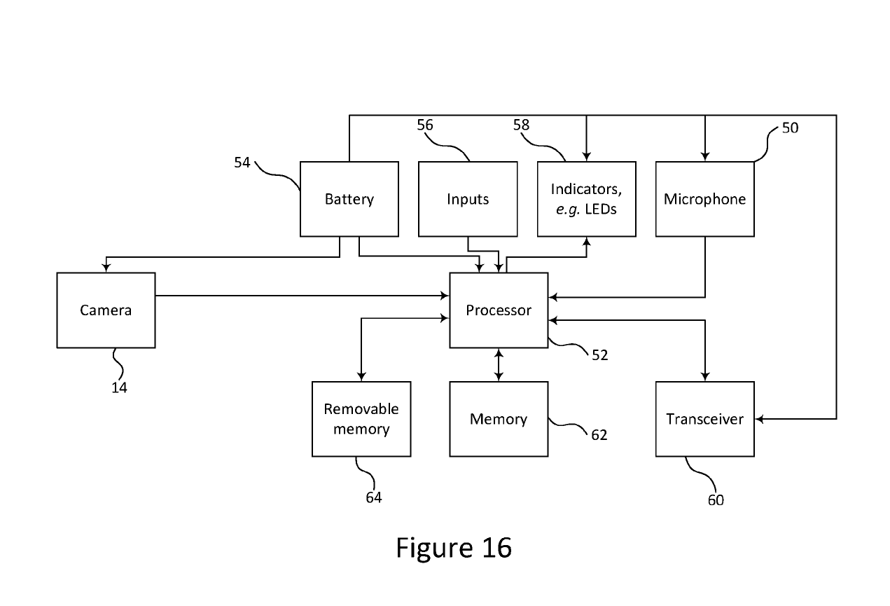

The eyewear may also comprise various components for operating the camera, as shown in FIG. 16. The camera 14 and a microphone 50 may be connected to a central processor 52. A battery is provided for powering the camera 14 and the processor 52. Inputs 56 such as a camera actuation switch communicate with the processor 52 for switching the camera on and off, and the processor is connected to indicators 58 such as an LED to show when the camera is operating. A transceiver 60 is provided for transmitting the images acquired by the camera, and the processor also has a built-in or embedded memory 62 for storing images, and/or a removable memory 64 such as a memory card. The memory 62 and/or removable memory 64 are provided with an anti-tamper or tamper-indication system to prevent or indicate manipulation or deletion of data stored in memory.

In one example, the eyewear is in the form of a set of goggles, such as military goggles for combat use or goggles that are used for skiing. In this case, the camera unit 14 is suitably mounted to the frame of the goggles.

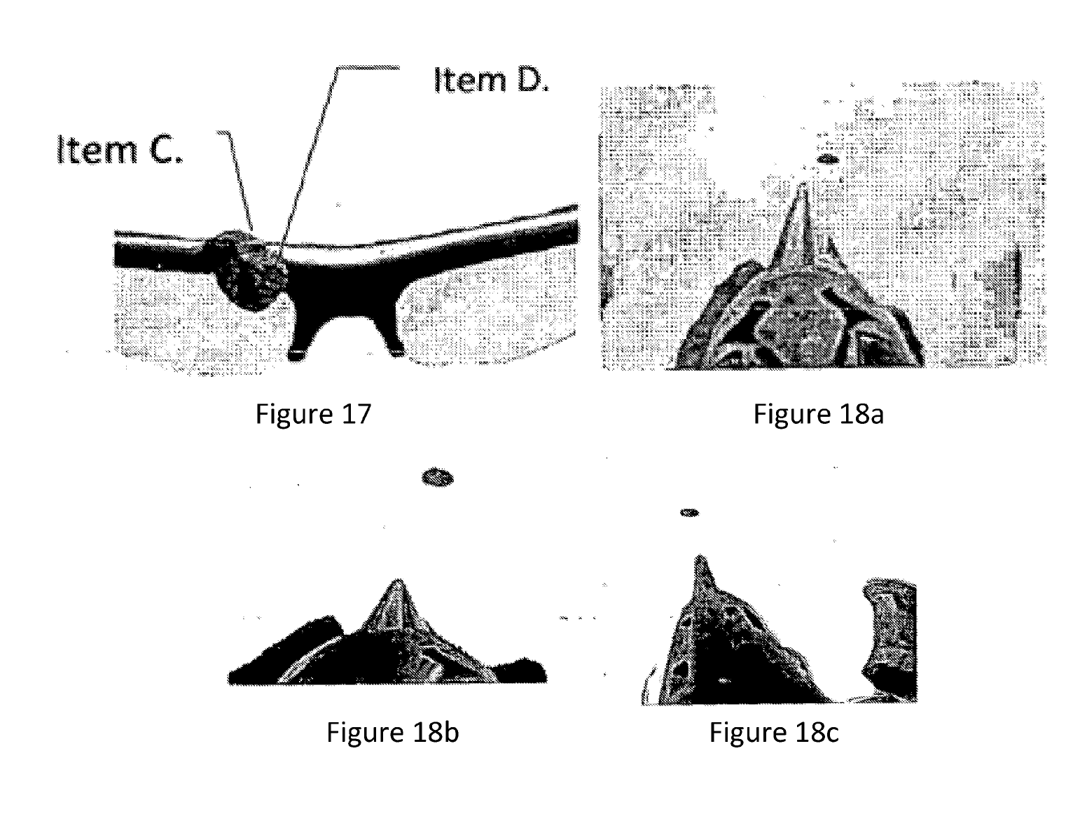

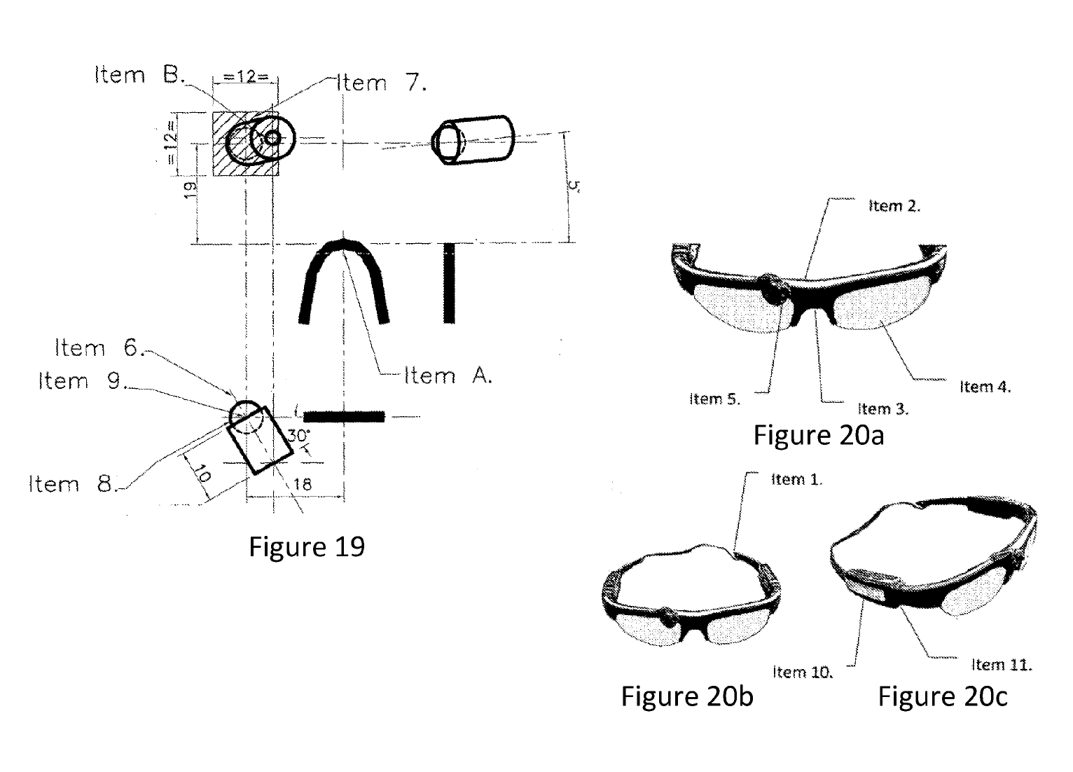

Referring to FIGS. 17 to 20, the drawings and pictures depict right hand user requirements. Left hand users would require the dimensions and angles mirrored about the vertical axis through the datum. To provide this range of adjustment the camera would be secured to the frame by a universal tensioned ball mount or other joint design allowing three axis movement that could be restrained after user adjustment.

The following drawing key applies to FIGS. 17 to 20:

### Item A—Apex of Nose Bridge=Datum

### Item B—Mini Video Camera Lens

### Item 6—Camera Centre

### Item 7—Hatched Area

### Item 8—A Universal Tensioned Three Axis Adjustable Joint

### Item 9—Rear of Camera

### Item C—Rear of Camera (Item 9). Attached to Frame by a Universal Tensioned Three Axis Adjustable Joint (Item 8).

Item D—Camera Centre (Item 6). May be positioned at any point within 12 mm square zone (Item 7).

### Item 1—Shooting Glasses

### Item 2—Frame

### Item 3—Central Nose Bridge

### Item 4—Lens

### Item 5—Camera

### Item 10—Data Storage Device

### Item 11—Microphone

In FIGS. 17-20, a pair of eyeglasses 1 for a user, particularly a shooter, comprises a bridge with a central nosepiece 3 and lenses 4, which may be prescribed or non-prescription if the shooter has 20-20 or similar vision, the bridge 2 being hinged at each end to temples (not shown) adapted to engage the wearer's ears. A camera 5 having a centre 6 is attached to the glasses 1, to one or other side of the nosepiece 3 depending on whether the shooter is left-handed, or right-handed. FIGS. 1 and 2 show the set up for a right-handed shooter.

The 12 mm square hatched area 7 shows the variable position of the centre point 6 of said camera 5.

A universal tensioned three axis adjustable joint 8 is positioned to the rear 9 of the camera 5.

The attached drawings and illustrations determines an active zone on a pair of shooting glasses that allow a video camera to be fixed and adjusted to produce video of: the view, seen from, the master eye, along the barrel of a gun, arrow fixed in bow etc and aligned with a target.

A data storage device 10 is removably attached to one or other of the temples, and is connected to the camera 5 to receive data from the camera 5.

A wearer activated device 10 is operable by the wearer, is connected to the camera 5 to activate the camera 5.

A microphone 11 is also mounted in the left or right temples and connected to the data storage device.

Other aspects of the invention are defined in the following clauses.

1. A pair of glasses for a user, comprising: an eyeglass frame having a digital camera at least partially embedded above left or right dominant eye, the digital camera being configured to acquire an individuals line of sight, such that the camera does not face directly forward but faces outward at an angle of approximately 30 degrees and records at least one picture or short video, a user activated device configured to receive a user input to activate acquisition of the individual picture by said camera; a data storage device configured to store one or more individual pictures or short videos acquired by said camera; and a microphone configured to acquire audio input to be recorded to said data storage device, wherein the acquired audio input stored in said data storage device is associated with the individual picture/video acquired by said camera and stored in said data storage device.
2. A pair of eyeglasses as recited in clause 1, wherein said eyeglass frame further includes a universal tensioned three axis adjustable joint and wherein said camera is mounted such that the camera does not face forward, but faces at an angle from the perpendicular direction of the plane formed by the lens holder adjacent to the nose bridge.
3. A pair of eyeglasses as recited in clause 1, wherein said camera is mounted on an angled surface at a forward portion of the eyeglass frame above the left or right eye.
4. A pair of eyeglasses with an angled camera as recited in clause 1, wherein the camera angle is set at approximately 30 degrees to the left above the right eye and 30 degrees to the right when positioned above the left eye.
5. A pair of eyeglasses as recited in clause 1, wherein said data storage device is removably coupled to the glasses on the first or second temple.
6. A pair of glasses for a user as recited in clause 1, wherein said removable memory card slot is provided at a lower portion of the one of the first or second temples.
7. A pair of eyeglasses as recited in clause 1, wherein said camera can be operated to automatically take at least one picture/video without any required user interaction after a previous picture/video is taken.
8. A pair of glasses as recited in clause 1, wherein, as stored in said data storage device, the acquired audio input is linked to at least the individual picture/video acquired by said camera.
9. A pair of glasses as recited in clause 1, wherein said camera or said user input device is configured to initiate storage of the acquired picture/video and audio input to said data storage device.
10. A pair of glasses as recited in clause 1, wherein the acquired audio input is acquired during a predetermined period of time proximate to when the individual picture is acquired by said camera.
11. A pair of glasses as recited in clause 1, wherein the acquired audio input comprises an audio recording of audio sounds at the location where the picture/video was taken.
12. A pair of glasses as recited in clause 1, wherein said pair of glasses further comprises: at least one electronic component for wireless connection, wherein the picture/video taken by said camera can be wirelessly transmitted to another device.
13. A pair of glasses as recited in claim 1, wherein said data storage device is a removable media card.
14. A pair of glasses as recited in clause 1, wherein said data storage device is a removable memory card, and wherein said pair of glasses further includes a connector adhered by or to one of the first and second temples, said connector being operatively connected to said camera, and wherein said removable memory card is configured to operatively connect with said connector to permit storage in said removable memory card of the one or more individual pictures/videos acquired by said camera.
15. A pair of glasses as recited in clause 14, wherein said connector is a USB or Mini jack plug connector.
16. A pair of glasses for a user, comprising: an eyeglass frame having at least first and second temples; a digital camera at least partially embedded in said eyeglass frame directly above the left or right eye, said camera being configured to acquire one or more images; a user input device configured to receive a user input to activate acquisition of the one or more images by said camera; and a removable memory card connector provided at one of the first and second temples, said removable memory card connector being electrically connected to said camera.
17. A pair of glasses for a user as recited in clause 16, wherein said removable memory card connector is adhered to or at least partially embedded within the one of the first and second temples.
18. A pair of glasses for a user as recited in clause 16, wherein the one or more images acquired by said camera are able to be stored to a removable memory card that is connected with said removable memory card connector.
19. A pair of glasses for a user, comprising: an eyeglass frame having at least first and second temples; a rechargeable battery power source at least partially embedded in said first or second temple frames.

It will be understood that the present invention has been described above purely by way of example, and modifications of detail can be made within the scope of the invention.

Reference numerals appearing in the claims are by way of illustration only and shall have no limiting effect on the scope of the claims.

1. Eyewear for acquiring an image comprising;
a frame arranged to be supported on a wearer's head to extend across the head in a position vertically adjacent at least one eye of a wearer; and
at least one front facing camera mounted to the frame so as to be substantially vertically aligned with the at least one eye, the camera having a camera axis for capturing the image;
in which the position of the camera axis relative to the frame is offset or is adjustable about a first substantially upright axis, for aligning the camera axis with the line of sight of the wearer.

2. Eyewear as claimed in claim 1, in which the position of the camera axis is offset or adjustable about a second substantially lateral axis, the second axis being perpendicular to the first axis, for aligning the camera axis with the line of sight of the wearer.

3. Eyewear as claimed in claim 1 or 2, in which the camera position is offset from an upright position relative to the frame about the camera axis, or is adjustable about the camera axis relative to the frame, for aligning the acquired image with a tilt angle of the wearer's head.

4. Eyewear as claimed in claim 1, 2 or 3, in which the camera comprises a camera body and a camera housing secured to the frame, and the camera axis is adjustable by relative movement between the camera body and the camera housing.

5. Eyewear as claimed in claim 4, comprising a locking member actuable selectively to permit relative movement between the camera body and the housing, or to secure the camera body in position in the housing.

6. Eyewear as claimed in claim 4 or 5, in which the camera body is substantially part spherical.

7. Eyewear as claimed in any preceding claim, in which the camera position relative to the frame is adjustable in translation along the frame for vertical alignment of the camera axis with the centre of the eye of the wearer.

8. Eyewear as claimed in claim 7, in which the frame comprised a camera mount portion, and the camera is arranged to be slidably engaged with the camera mount for translational movement thereon, and is arranged to be selectively secured in position on the mount.

9. Eyewear as claimed in any preceding claim, in which the height of the camera relative to the wearer's eye is adjustable.

10. Eyewear as claimed in claim 9, in which the height of the camera is adjustable by adjusting the position of the frame on the wearer's head.

11. Eyewear as claimed in any preceding claim, comprising apparatus for recording the acquired image as at least one picture or video.

12. Eyewear as claimed in any preceding claim, in which the camera axis is offset to face outwardly at an angle of approximately 30 degrees, or is adjustable within a range from about 10 degrees inwardly to about 30 degrees outwardly.

13. Eyewear as claimed in any preceding claim, in which the camera axis is offset to face upwardly at an angle of approximately 5 degrees, or is adjustable within a range from about 10 degrees downwardly to about 30 degrees upwardly.

14. Eyewear as claimed in any preceding claim, in which the camera position is offset about the camera axis by approximately 5 degrees, or is adjustable in a range between about 20 degrees in either direction.

15. Eyewear as claimed in claim comprising a device for receiving a user input, the device being arranged to initiate image acquisition by the camera.

16. Eyewear as claimed in claim, comprising a microphone for acquiring audio input associated with a picture and/or video acquired by the camera

17. Eyewear as claimed in claim, comprising a data storage device for storing the image(s) or video or audio input.

18. Eyewear as claimed in any preceding claim, in which the frame is arranged to extend adjacent both eyes of the wearer.

19. Eyewear as claimed in claim 17, comprising two cameras each being substantially aligned with one eye of the wearer.

20. A kit of parts comprising:
eyewear as claimed in claim 8 or any of claims 9 to 19 when dependent upon claim 8;
at least one pair of removable lenses for attaching to the frame of the eyewear;
at least one camera unit for attaching to the camera mount portion of the frame;
at least one moulding for covering the camera mount portion of the frame; and
a tool for adjusting the position of the camera unit.

21. Eyewear substantially as described herein and/or substantially as illustrated with reference to the accompanying drawings.

22. A kit of parts substantially as described herein and/or substantially as illustrated with reference to the accompanying drawings.
